(19) United States
(12) Patent Application Publication
(10) Pub. No.: US 2024/0228822 A9
(43) Pub. Date: Jul. 11, 2024

(54) CURABLE FILM-FORMING COMPOSITIONS DEMONSTRATING ADHESION TO DIVERSE SUBSTRATES AND FAST SANDABILITY

(71) Applicant: PPG Industries Ohio, Inc., Cleveland, OH (US)

(72) Inventors: Ian Michael Jones, Pittsburgh, PA (US); Davina J. Schwartzmiller, Rural Valley, PA (US); Scott J. Moravek, Mars, PA (US)

(73) Assignee: PPG Industries Ohio, Inc., Cleveland, OH (US)

(21) Appl. No.: 18/547,350

(22) PCT Filed: Oct. 19, 2021
(86) PCT No.: PCT/US2021/055669

§ 371 Date: Aug. 22, 2023

Related U.S. Application Data
(60) Provisional application No. 63/174,229, filed on Apr. 13, 2021.
(60) Provisional application No. 63/152,385, filed on Feb. 23, 2021.

(51) Int. Cl. C09D 163/00; C08J 7/052; C09D 7/61; C09D 7/63

(52) U.S. Cl. CPC C09D 163/00; C08J 7/052; C09D 7/61; C09D 7/63; C08J 2363/00

(57) ABSTRACT

The present invention is directed to curable film-forming compositions and coating kits, each comprising: (a) a polyepoxide functional polymer; (b) a polythiol functional compound, wherein the polythiol functional compound comprises at least two or at least three thiol functional groups and wherein if the polythiol functional compound contains hydroxyl functional groups, the ratio of thiol functional groups to hydroxyl functional groups within the polythiol functional compound is not 1:1; (c) a reactive compound different from the polythiol functional compound (b), containing multiple pendant and/or terminal functional groups selected from carboxylic acid, anhydride, amine and phenol that are reactive with epoxide functional groups; and (d) a pigment. The curable film-forming composition demonstrates a pigment to binder ratio greater than or equal to 2 and less than 3, adhesion to diverse substrates, and fast sandability. The present invention is further directed to coated articles and methods of forming them.

### FIELD OF THE INVENTION

The present invention relates to curable film-forming compositions demonstrating adhesion to diverse substrates and fast sandability.

### BACKGROUND OF THE INVENTION

In the automotive refinish industry, a typical multilayer coating stack applied to a substrate includes a primer, optionally a sealer, and one or more aesthetic topcoats. The substrate, primer and any sealer are usually sanded between applications for adhesion and appearance purposes. For the sake of convenience it is desired that each coating dry and/or cure to an extent that it may be sandable, if necessary, within two hours of application. Each sandable coating is also designed to provide high film build with a minimum of coating layers, yielding smoothness and leveling for superior appearance that replicates the OEM finish.

Primer compositions that can be applied directly to both metal substrates and other substrates with equivalent adhesion and without formulation changes are particularly sought after for ease of use, especially in automotive refinish and other ambient-cure coating markets. Current technology typically only provides one of these properties within a single product. For example, epoxy amine primers have good adhesion, but require a long dry time before being sandable. Polyurethane primers are sandable soon after application but have poor adhesion to metal.

It would be desirable to provide curable film-forming compositions that may be applied directly to metal substrates as primers, with comparable adhesion properties over diverse substrates and fast sandability.

### SUMMARY OF THE INVENTION

The present invention is directed to curable film-forming compositions and coating kits, each comprising:
(a) a polyepoxide functional polymer;
(b) a polythiol functional compound, wherein the polythiol functional compound comprises at least two or at least three thiol functional groups and wherein if the polythiol functional compound contains hydroxyl functional groups, the ratio of thiol functional groups to hydroxyl functional groups within the polythiol functional compound is not 1:1;
   (c) a reactive compound different from the polythiol functional compound (b), containing multiple pendant and/or terminal functional groups selected from carboxylic acid, anhydride, amine and phenol that are reactive with epoxide functional groups; and
(d) a pigment. The curable film-forming composition demonstrates a pigment to binder ratio greater than or equal to 2 and less than 3.

The present invention is further directed to methods of forming a coated article, comprising:
(a) applying the curable film-forming composition described above directly to at least a portion of at least one substrate to form at least one coated substrate; and
(b) subjecting the at least one coated substrate to a temperature of at least 0° C., or at least 10° C., or at least 20° C., and at most 60° C., or at most 40° C., or at most 30° C. to cause curing of the curable film-forming composition. Each coated substrate passes the SANDABILITY TEST (defined below) less than two hours after application of the curable film-forming composition to the substrate(s). Additionally or alternatively, each coated substrate demonstrates an adhesion rating of 0 to 2 within seven days after application of the curable film-forming composition to each substrate, when subjected to ISO 2409:2013(E) using a hand-held single blade cutting tool making cuts with 2 mm spacing.

The present invention is further directed to coated articles comprising a substrate and the curable film-forming composition described above applied to at least one surface of the substrate. The present invention is also directed to coated articles prepared by the method described above.

### DETAILED DESCRIPTION OF THE INVENTION

Other than in the operating examples, or unless otherwise expressly specified, all of the numerical ranges, amounts, values and percentages such as those for amounts of materials, times and temperatures of reaction, ratios of amounts, values for molecular weight (whether number average molecular weight (“Mn”) or weight average molecular weight (“Mw”)), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Plural referents as used herein encompass singular and vice versa. For example, while the invention has been described in terms of “a” polyepoxide functional polymer, a plurality, including a mixture of such polymers, can be used.

Any numeric references to amounts, unless otherwise specified, are “by weight”. The term “equivalent weight” is a calculated value based on the relative amounts of the various ingredients used in making the specified material and is based on the solids of the specified material. The relative amounts are those that result in the theoretical weight in grams of the material, like a polymer, produced from the ingredients and give a theoretical number of the particular functional group that is present in the resulting polymer. The theoretical polymer weight is divided by the theoretical number of equivalents of functional groups to give the equivalent weight. For example, urethane equivalent weight is based on the equivalents of urethane groups in the polyurethane material.

The various examples of the present invention as presented herein are each understood to be non-limiting with respect to the scope of the invention.

The curable film-forming compositions and coating kits of the present invention comprise (a) a polyepoxide functional polymer (“polyepoxide”). As used herein, the terms “thermosetting” and “curable” can be used interchangeably and refer to resins that “set” irreversibly upon curing or crosslinking, wherein the polymer chains of the polymeric components are joined together by covalent bonds. This property is usually associated with a crosslinking reaction of the composition constituents often induced, for example, by heat or radiation. See Hawley, Gessner G., The Condensed Chemical Dictionary, Ninth Edition, page 856; Surface Coatings, vol. 2, Oil and Colour Chemists' Association, Australia, TAFE Educational Books (1974). Curing or crosslinking reactions also may be carried out under ambient conditions. By ambient conditions is meant that the coating undergoes a thermosetting reaction without the aid of heat or other energy, for example, without baking in an oven, use of forced air, or the like. Usually ambient temperature ranges from 60 to 90° F. (15.6 to 32.2° C.), such as a typical room temperature, 72° F. (22.2° C.). Once cured or crosslinked, a thermosetting resin will not melt upon the application of heat and is insoluble in solvents. For example, a “cured composition” of some specific description, means that at least a portion of the polymerizable and/or crosslinkable components that form the curable composition is polymerized and/or crosslinked through reactive functional groups, to the extent that a cured film prepared from the composition demonstrates no damage from at least 50 methylethyl ketone (MEK) double rubs according to ASTM D5402-19. The test method may be performed, for example, using the specified cheesecloth or another suitable cloth such as a Wypall X80 towel available from Kimberly Clark Corporation. Additionally, curing of a polymerizable composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive groups occurs, the rate of reaction of the remaining unreacted reactive groups becomes progressively slower. The polymerizable composition can be subjected to curing conditions until it is at least partially cured. The term “at least partially cured” means subjecting the polymerizable composition to curing conditions, wherein reaction of at least a portion (e.g., at least 5 percent) of the reactive groups of the composition occurs, to form a polymerizate. The polymerizable composition can also be subjected to curing conditions such that a complete cure is attained (for example, greater than 50 percent of reactive groups, or greater than 60 percent of reactive groups, or greater than 80 percent of reactive groups have reacted) and wherein further curing results in no further improvement in polymer properties, such as hardness.

As used in this specification and the appended claims, the articles “a,” “an,” and “the” include plural referents, and are used interchangeably with the terms “at least one” and “one or more”, unless expressly and unequivocally limited to one referent. As used herein, the term “polymer” is meant to refer to oligomers and both homopolymers and copolymers as understood in the art.

Often the polyepoxide functional polymer (a) comprises a non-acrylic polyepoxide functional polymer. Suitable polyepoxide functional polymers include, for example, a polyepoxide chain-extended by reacting together a polyepoxide and a polyhydroxyl group-containing material such as alcoholic hydroxyl group-containing materials and phenolic hydroxyl group-containing materials (thus providing aromatic groups to the polyepoxide functional polymer if desired) to chain extend or build the molecular weight of the polyepoxide.

A chain-extended polyepoxide is typically prepared by reacting together the polyepoxide and polyhydroxyl group-containing material neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of about 80° C. to 160° C. for about 30 to 180 minutes until an epoxy group-containing resinous reaction product is obtained.

The equivalent ratio of reactants, i.e., epoxy:polyhydroxyl group-containing material, is typically from about 1.00:0.75 to 1.00:2.00.

The polyepoxide by definition has at least two 1,2-epoxy groups. In general, the epoxide equivalent weight of the polyepoxide will range from 100 to about 2000, typically from about 180 to 500. The epoxy compounds may be saturated or unsaturated, cyclic or acyclic, aliphatic, alicyclic, aromatic or heterocyclic. They may contain substituents such as halogen, hydroxyl, and ether groups.

Examples of polyepoxides are those having a 1,2-epoxy equivalency greater than one and usually about two; that is, polyepoxides which have on average two epoxide groups per molecule. The most commonly used polyepoxides are polyglycidyl ethers of cyclic polyols, for example, polyglycidyl ethers of polyhydric phenols such as Bisphenol A, resorcinol, hydroquinone, benzenedimethanol, phloroglucinol, and catechol; or polyglycidyl ethers of polyhydric alcohols such as alicyclic polyols, particularly cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Polyhydroxyl group-containing materials used to chain extend or increase the molecular weight of the polyepoxide may be polymeric polyols.

Polyesters, polyurethanes, or polyamides prepared with glycidyl alcohols or glycidyl amines, or reacted with an epihalohydrin are also suitable epoxy functional resins.

Non-limiting examples of suitable polyepoxide functional polymers include EPON 828 and 1001, commercially available from Miller-Stephenson, Inc., and D. E. N. 431, a novolac-based polyepoxide resin available from Olin Epoxy, Olin Corporation.

Usually the polyepoxide functional polymer (a) comprises less than 25 percent by weight, or less than 20 percent by weight, or less than 15 percent by weight, or less than 10 percent by weight of an acrylic polyepoxide functional polymer, based on the total weight of polyepoxide functional polymer (a) in the curable film-forming composition. In particular examples of the present invention, the polyepoxide functional polymer (a) does not comprise or include an acrylic polyepoxide functional polymer.

The polyepoxide functional polymer (a) typically has number average molecular weights ranging from about 180 to 500, often from about 186 to 350. Molecular weights, whether number average (Me) or weight average (Mw), are determined by gel permeation chromatography using polystyrene as standards as is well known to those skilled in the art and such as is discussed in U.S. Pat. No. 4,739,019, at column 4, lines 2-45.

The polyepoxide functional polymer (a) is typically present in the curable film-forming composition of the present invention in an amount of at least 10, such as at least 20, or least 35, or at least 40, or at least 45 percent by weight, based on the total weight of resin solids (i.e., the total weight of (a), (b), and (c)) in the curable film-forming composition. The polyepoxide (a) may be present in the curable film-forming composition of the present invention in an amount of at most 90, such as at most 85, or at most 80 percent by weight, based on the total weight of resin solids in the curable film-forming composition. Thus, the polyepoxide may be present in the curable film-forming composition in an amount, for example, of 10 to 90 percent by weight, or 10 to 85 percent by weight, or 10 to 80 percent by weight, or 20 to 90 percent by weight, or 20 to 85 percent by weight, or 20 to 80 percent by weight, or 35 to 90 percent by weight, or 35 to 85 percent by weight, or 35 to 80 percent by weight, or 40 to 90 percent by weight, or 40 to 85 percent by weight, or 40 to 80 percent by weight, or 45 to 90 percent by weight, or 45 to 85 percent by weight, or 45 to 80 percent by weight.

As used herein “based on the total weight of resin solids” means that the amount of the component added during the formation of the composition is based upon the total weight of the non-volatile resins of the film forming materials, including cross-linkers, reactive diluents, and polymers present during the formation of the composition, but not including any water, volatile organic solvent, or any additive solids such as hindered amine stabilizers, photoinitiators, pigments including extender pigments and fillers, flow modifiers, catalysts, and UV light absorbers, unless otherwise indicated. The phrases “based on the total solid weight” and “based on the total weight of solids” (used interchangeably) of the composition means that the amount of the component added during the formation of the composition is based upon the total weight of the solids (non-volatiles) of the film forming materials, including cross-linkers, reactive diluents, and polymers, pigments including extender pigments and fillers, additive solids such as hindered amine stabilizers, photoinitiators, flow modifiers, catalysts, and UV light absorbers present during the formation of the composition, but not including any water or volatile organic solvent, unless otherwise indicated.

The curable film-forming compositions and coating kits of the present invention further comprise (b) a polythiol functional compound. The polythiol functional compound comprises at least two, often at least three thiol functional groups. If the polythiol functional compound contains hydroxyl functional groups, the ratio of thiol functional groups to hydroxyl functional groups within the polythiol functional compound is not 1:1. Usually, if the polythiol functional compound (b) contains hydroxyl functional groups, the ratio of thiol functional groups to hydroxyl functional groups within the polythiol functional compound (b) is greater than 1:1. More often, the polythiol functional compound (b) does not contain hydroxyl functional groups or any other reactive functional groups, such as other active hydrogen groups, other than thiol.

Suitable polythiol functional compounds (b) for use in the curable composition according to the present invention include polythiols having at least two, or more often at least three thiol groups per molecule, including monomeric compounds, oligomers, prepolymers and polymers. The polythiol typically does not have ether linkages (—O—). Thioether linkages (—S—), including polysulfide linkages (—Sₓ—), wherein x is at least 2, such as from 2 to 4, and combinations of such linkages, are not recommended. Typically, the curable film-forming composition is essentially free of polysulfides and polythioethers. By “essentially free” of a material is meant that a composition has only trace or incidental amounts of a given material, and that the material is not present in an amount sufficient to affect any properties of the composition. These materials are not essential to the composition and hence the composition is free of these materials in any appreciable or essential amount. If they are present, it is in incidental amounts only, typically less than 0.1 percent by weight, based on the total weight of solids in the composition.

The polythiols (b) for use in the present invention include materials of the formula:

R¹—(SH)ₙ

wherein R¹ is an organic moiety and n is an integer of at least 2, or at least 3, typically 3 to 6. Such a polythiol may for instance comprise a reaction product of a thiol-functional organic acid and a polyol. Accordingly, the organic moiety R 1 can contain ester groups and/or be derived from a polyol. Often the polythiol compound (b) contains ester groups. In a particular example of the present invention, the polythiol functional compound (b) has at least two ester functional groups and is tetrafunctional with respect to thiol functional groups.

Examples of suitable polythiols that can be used in the curable compositions according to the present invention may include esters of thiol-containing acids of the formula HS—R²—COOH, wherein R 2 comprises a divalent organic moiety typically having 1 to 4 carbon atoms, reacted with polyhydroxy compounds of the structure R³—(OH)ₙ wherein R³ comprises an n-valent organic moiety typically having 4 to 13 carbon atoms and n is at least 2, more often at least 3, typically 3 to 6. The thiol-containing acid component and the polyhydroxy component can be reacted under suitable conditions to give polythiols having the general structure:

R³—(OC(═O)—R²—SH)ₙ

Examples of such esters of thiol-containing acids include esters of thioglycolic acid (HS—CH₂COOH), α-mercaptopropionic acid (HS—CH(CH₃)—COOH) or β-mercaptopropionic acid (HS—CH₂CH₂COOH) reacted with polyhydroxy compounds such as triols, tetraols, pentaols, hexaols, and mixtures thereof. Specific examples of suitable polythiol functional compounds (b) include, for instance, trimethylolpropane tris (thioglycolate), trimethylolpropane tris (β-mercaptopropionate), pentaerythritol tetrakis (thioglycolate) and pentaerythritol tetrakis (β-mercaptopropionate), and mixtures thereof. Typically, such a polythiol functional compound (b) has a thiol equivalent weight less than 330 g/equivalent, or less than 300 g/equivalent, or less than 200 g/equivalent, or less than 135 g/equivalent. A particular example of a polythiol that is suitable for use in the curable film-forming composition of the present invention is THIOCURE PETMP (pentaerythritol tetra(3-mercaptopropionate)), commercially available from Bruno Bock Chemische Fabrik GmbH & Co. KG. When the polythiol (b) has two thiol functional groups, the polythiol functional compound (b) typically has a thiol equivalent weight less than 300 g/equivalent, or less than 200 g/equivalent, or less than 135 g/equivalent.

The polythiol (b) is typically present in the curable composition of the present invention in an amount of 5 to 90 percent by weight, based on the total weight of resin solids in the curable composition. For example, the polythiol (b) may be present in the curable composition in an amount of at least 5 percent by weight, or at least 10 percent by weight, or at least 30 percent by weight, or at least 50 percent by weight, or even at least 60 percent by weight, based on the total weight of resin solids in the curable composition, as demonstrated in the examples below. Moreover, the polythiol (b) may be present in the curable composition in an amount up to 75 percent by weight, often up to 60 percent by weight, based on the total weight of resin solids in the curable composition. Thus, the polythiol may be present in the curable film-forming composition in an amount, for example, of 5 to 90 percent by weight, or 5 to 75 percent by weight, or 5 to 60 percent by weight, or 10 to 90 percent by weight, or 10 to 75 percent by weight, or 10 to 60 percent by weight, or 30 to 90 percent by weight, or 30 to 75 percent by weight, or 30 to 60 percent by weight, or 50 to 90 percent by weight, or 50 to 75 percent by weight, or 50 to 60 percent by weight, or 60 to 90 percent by weight, or 60 to 75 percent by weight.

The curable film-forming compositions and coating kits of the present invention further comprise (c) a reactive compound containing functional groups that are reactive with epoxide functional groups. The reactive compound (c) is different from the polythiol functional compound (b). The term “reactive” refers to a functional group capable of undergoing a chemical reaction with itself and/or other functional groups spontaneously or upon the application of heat or in the presence of a catalyst or by any other means known to those skilled in the art. Reactive functional groups present on the reactive compound (c) may include carboxylic acid, anhydride, amine, and/or phenol. Non-limiting examples of such compounds include acrylic, polyester, polyurethane, polyether, and/or polyamide polymers with multiple pendant and/or terminal reactive functional groups such as any of those listed above. However, the reactive compound (c) need not be polymeric. Examples of suitable polycarboxylic acids include adipic, succinic, sebacic, azelaic, and dodecanedioic acid. Anhydrides may include, inter alia, phthalic anhydride, tetrahydrophthalic anhydride, hexahydrophthalic anhydride, methylhexahydrophthalic anhydride, chlorendic anhydride, and the like. Mixtures of acids and/or anhydrides may also be used. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

Nonlimiting examples of suitable polyamines include primary or secondary diamines or polyamines in which the radicals attached to the nitrogen atoms can be saturated or unsaturated, aliphatic, alicyclic, aromatic, aromatic-substituted-aliphatic, aliphatic-substituted-aromatic, and heterocyclic. Nonlimiting examples of suitable aliphatic and alicyclic diamines include ethylene diamine, 1,2-diaminopropane, 1,5-diamino-2-methylpentane, 1,3-diaminopentane, 1,2-diaminocyclohexane, 1,6-diaminohexane, 1,11-diaminoundecane, 1,12-diaminododecane, 3-(cyclohexylamino)propylamine, 3-aminomethyl-3,5,5-trimethylcyclohexan-1-amine (isophorone diamine (“IPDA”)), 4,4′-diaminodicyclohexylmethane, 3,3′-dimethyl-4,4′-diaminodicyclohexyl methane, 3,3′-[1,4-butanediylbis-(oxy)bis]-1-propanamine, methanediamine, and diamino functional polyether polyamines having aliphatically bound primary amino groups, examples of which include JEFFAMINE D-230, JEFFAMINE D-400, JEFFAMINE D-2000, and JEFFAMINE D-4000, available from Huntsman Corporation. Nonlimiting examples of suitable aromatic diamines include phenylene diamines and toluene diamines, for example o-phenylene diamine and p-tolylene diamine. Polynuclear aromatic diamines such as 4,4′-biphenyl diamine, methylene dianiline and monochloromethylene dianiline are also suitable.

Cycloaliphatic diamines are available commercially from Huntsman Corporation (Houston, TX) under the designation of JEFFLINK™ such as JEFFLINK™ 754. Additional aliphatic cyclic polyamines may also be used, such as DESMOPHEN NH 1520 available from Bayer MaterialScience and/or CLEARLINK 1000, which is a secondary aliphatic diamine available from Dorf Ketal. POLYCLEAR 136 (available from BASF/Hansen Group LLC), the reaction product of isophorone diamine and acrylonitrile, is also suitable.

Suitable higher polyamines include primary and secondary triamines and/or tetramines. Examples of suitable triamines include but are not limited to diethylene triamine, dipropylene triamine, bis(hexamethylene) triamine and triamino functional polyetherpolyamines having aliphatically bound primary amino groups (examples include JEFFAMINE T-403, T-3000, T-5000, available from Huntsman Corporation). For example, the amine can be an amine terminated (that is, an amine on each end, thus rendering the amine difunctional) polyethylene or polypropylene glycol.

Suitable compounds with phenolic functional groups include Phenodur PR 263/70B, available from Allnex USA, Inc.

Often the reactive compound (c) contains multiple reactive (such as primary or secondary) amine functional groups. Particular examples include polyamidoamines such as Delfleet Evolution F3996, available from PPG Industries Automotive Refinish, and phenolic polyamines such as Accelerator 2950 CH, available from Huntsman Corporation.

In particular examples of the present invention, the weight ratio of the polythiol functional compound (b) to the reactive compound (c) is less than or equal to 10, or less than or equal to 9.5, or less than or equal to 9, or less than or equal to 8.5, or less than or equal to 8.

In particular examples of the present invention, the equivalent ratio of the thiol (active hydrogen) groups in the polythiol functional compound (b) to the reactive (active hydrogen) functional groups in the reactive compound (c) is from 4:1 to 1:4, or from 3:1 to 1:3, or from 2:1 to 1:2, such as 4:1, or 3.5:1, or 2.5:1, or 1.5:4, or 1.5:3, or 1.5:2.

Typically, the reactive compound (c) is present in the curable film-forming composition in an amount of at least 1 percent by weight, or at least 2 percent by weight, or at least 5 percent by weight, and at most 15 percent by weight, or at most 12 percent by weight, or at most 10 percent by weight, based on the total weight of resin solids in the curable film-forming composition. Thus, the reactive compound (c) may be present in the curable film-forming composition in an amount, for example, of 1 to 15 percent by weight, or 1 to 12 percent by weight, or 1 to 10 percent by weight, or 2 to 15 percent by weight, or 2 to 12 percent by weight, or 2 to 10 percent by weight, or 5 to 15 percent by weight, or 5 to 12 percent by weight, or 5 to 10 percent by weight.

The curable film-forming compositions and coating kits of the present invention further comprise (d) a pigment. By “pigment” is meant colorants, extenders, filler particles, and/or corrosion inhibiting pigments. The pigment can be added to the coating in any suitable form, such as discrete particles, dispersions, solutions and/or flakes. A colorant can be organic or inorganic and can be agglomerated or non-agglomerated. Colorants and other pigments can be incorporated into the coatings by grinding or simple mixing. Colorants and other pigments can be incorporated by grinding into the coating by use of a grind vehicle, such as an acrylic grind vehicle, the use of which will be familiar to one skilled in the art. A single pigment or a mixture of two or more pigments can be used in the coatings of the present invention.

Suitable pigments include any of those known in the art of surface coatings. Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof.

Particular examples of pigments for primer compositions include carbon black, titanium dioxide, barium sulfate, magnesium silicate, aluminum silicate, silica, corrosion inhibiting pigments, and the like. The pigment is usually not thermally conductive. Typically, the curable film-forming compositions and coating kits of the present invention demonstrate a pigment to binder ratio (P:B) greater than or equal to 2 and less than 3. By “pigment to binder ratio” is meant the solid weight ratio of the pigment (d), including colorants, extenders, filler particles, and/or corrosion inhibiting pigments, to components (a)+(b)+(c).

The curable film-forming compositions and coating kits of the present invention may contain adjunct ingredients conventionally used in coating compositions. Optional ingredients such as, for example, catalysts, plasticizers, surfactants, thixotropic agents and/or other rheology control agents, matting agents, organic cosolvents, flow controllers, anti-oxidants, UV light absorbers (such as in a topcoat composition), corrosion inhibitors, and similar additives conventional in the art may be included in the compositions. These ingredients are typically present at up to about 40% by weight based on the total weight of resin solids.

A catalyst selected from oxazolidines, alkyl amino phenols, triethylamine, dimethylcyclohexylamine, dimethyloctylamine, dimethyldodecylamine, dimethylamino ethanol, tetramethyl guanidine, diaza-bicyclo-octane, diaza-bicyclo-undecene, diaza-bicyclo-nonene, n-methyl-triaza-bicyclodecene, and mixtures thereof, may be particularly suitable.

It has been found that inclusion of various zinc compounds (zinc phosphate, zinc carboxylate, zinc aluminum phosphate) typically used in the art for corrosion inhibition causes an undesirable increase in viscosity of the composition, likely due to the complexation of the thiol with the zinc. However, strontium zinc phosphosilicate corrosion inhibitor can be combined with the polythiol without increasing the viscosity. In particular examples of the present invention, the composition further comprises strontium zinc phosphosilicate in an amount at least 1 percent by weight, or at least 5 percent by weight, or at least 10 percent by weight, and at most 30 percent by weight, or at most 27 percent by weight, or at most 25 percent by weight, based on the total weight of resin solids in the curable film-forming composition. Thus, the strontium zinc phosphosilicate may be present in the curable film-forming composition in an amount, for example, of 1 to 30 percent by weight, or 1 to 27 percent by weight, or 1 to 25 percent by weight, or 5 to 30 percent by weight, or 5 to 27 percent by weight, or 5 to 25 percent by weight, or 10 to 30 percent by weight, or 10 to 27 percent by weight, or 10 to 25 percent by weight.

The curable film-forming compositions and coating kits of the present invention are typically solventborne. Suitable organic solvent media include ketones, such as methyl amyl ketone and methyl isobutyl ketone; aromatic hydrocarbons, such as xylene; glycol ethers, such as propylene glycol methyl ether, propylene glycol monopropyl ether, ethylene glycol monobutyl ether, dipropylene glycol monomethyl ether, and ethylene glycol monohexyl ether; and/or esters such as n-butyl acetate, 2-butoxyethyl ester of acetic acid, and propylene glycol monomethyl ether acetate. Other solvents including alcohols, such as butanol, may be suitable. Mixtures of any of the foregoing solvents may also be used. The total solids content of the curable film-forming compositions of the present invention may be at least 20, or at least 30, or at least 40, or at least 50 percent by weight, based on the total weight of the curable film-forming composition, and at most 90, or at most 80 or at most 75, or at most 70 percent by weight, based on the total weight of the curable film-forming composition. Thus, the total solids content of the curable film-forming compositions of the present invention may range from 20 to 90 percent by weight, or 20 to 80 percent by weight, or 20 to 75 percent by weight, or 20 to 70 percent by weight, or 30 to 90 percent by weight, or 30 to 80 percent by weight, or 30 to 75 percent by weight, or 30 to 70 percent by weight, or 40 to 90 percent by weight, or 40 to 80 percent by weight, or 40 to 75 percent by weight, or 40 to 70 percent by weight, or 50 to 90 percent by weight, or 50 to 80 percent by weight, or 50 to 75 percent by weight, or 50 to 70 percent by weight.

In particular examples of the present invention the composition is essentially free of chromate compounds, such as pigments containing chromate.

As noted above, the present invention is also drawn to coating kits. It is often not practical to store ambient-cure coatings as a one-package composition, but rather they must be stored as multi-package coatings to prevent the reactive constituents from curing prior to use. The term “multi-package coatings” refers to coatings in which various constituents are maintained separately until just prior to application. The coating kits of the present invention are usually multi-package coatings comprising multiple, separate components, such as wherein a first component comprises the polyepoxide functional polymer (a), a second component comprises the polythiol functional compound (b), and a third component comprises the reactive compound (c). The pigment (d) may be present in one or more of the other components or as a separate fourth component; typically, the pigment (d) is present in the first component and/or the third component. In another example, a first component comprises the polyepoxide functional polymer (a), and a second component comprises the polythiol functional compound (b) and the reactive compound (c). In this case, the pigment (d) may be present in one or more of the other components (usually in the first) or as a separate third component. In the examples shown below, the polyepoxide functional polymer (a) serves as a grind vehicle for the pigment (d).

The present invention is further drawn to a coated article comprising a substrate and the curable film-forming composition described above applied to at least one surface of the substrate. The curable film-forming composition may serve as a primer, sealer, basecoat, and/or direct gloss topcoat, imparting a decorative and/or protective finish to the substrate.

Non-metallic substrates A) include polymeric, plastic, polyester, polyolefin, polyamide, cellulosic, polystyrene, polyacrylic, poly(ethylene naphthalate), polypropylene, polyethylene, nylon, EVOH, poly(lactic acid), other “green” polymeric substrates, poly(ethylene terephthalate) (“PET”), polycarbonate, polycarbonate acrylonitrile butadiene styrene (“PC/ABS”), polyamide, polymer composites and the like. Car parts typically formed from thermoplastic and thermoset materials include bumpers and trim.

The metal substrates used in the present invention include ferrous metals, non-ferrous metals and combinations thereof. Suitable ferrous metals include iron, steel, and alloys thereof. Non-limiting examples of useful steel materials include cold rolled steel, pickled steel, steel surface-treated with any of zinc metal, zinc compounds and zinc alloys (including electrogalvanized steel, hot-dipped galvanized steel, GALVANNEAL steel, and steel plated with zinc alloy) and/or zinc-iron alloys. Also, aluminum, aluminum alloys, zinc-aluminum alloys such as GALFAN, GALVALUME, aluminum plated steel and aluminum alloy plated steel substrates may be used, as well as magnesium metal, titanium metal, and alloys thereof. Steel substrates (such as cold rolled steel or any of the steel substrates listed above) coated with a weldable, zinc-rich or iron phosphide-rich organic coating are also suitable for use in the present invention. Such weldable coating compositions are disclosed in U.S. Pat. Nos. 4,157,924 and 4,186,036. Cold rolled steel is also suitable when pretreated with an appropriate solution known in the art, such as a metal phosphate solution, an aqueous solution containing at least one Group IIIB or IVB metal, an organophosphate solution, an organophosphonate solution, and combinations thereof, as discussed below.

The substrate may alternatively comprise more than one metal or metal alloy in that the substrate may be a combination of two or more metal substrates assembled together such as hot-dipped galvanized steel assembled with aluminum substrates. The substrate may alternatively comprise a composite material such as a fiberglass composite. The coated articles of the present invention can comprise at least two different substrates, which may include both metal and non-metal parts, to which the curable film-forming composition is applied with acceptable adhesion on each substrate.

The coated article may comprise part of a vehicle, prepared using one or more suitable substrates. “Vehicle” is used herein in its broadest sense and includes all types of vehicles, such as but not limited to airplanes, helicopters, cars, trucks, buses, vans, golf carts, motorcycles, bicycles, railroad cars, tanks and the like. It will be appreciated that the portion of the vehicle that is coated according to the present invention may vary depending on why the coating is being used.

The shape of the substrate can be in the form of a sheet, plate, bar, rod or any shape desired, but it is usually in the form of an automobile part, such as a body, door, fender, hood or bumper. The thickness of the substrate can vary as desired.

The coated article may alternatively comprise a component of a building, bridge, industrial protective structure, ship, railcar, railcar container, water tower, power line tower, tunnel, oil or gas industry structure, marine structure, aerospace structure, bridge support structure, pipeline, oil rig, storage tank, or wind turbine, again, prepared using one or more suitable substrates.

Metal substrates to be used may be bare substrates such that the curable film-forming composition is applied as a direct-to-metal (DTM) coating. By “bare” is meant a virgin substrate that has not been treated with (or has been stripped of) any pretreatment compositions such as conventional phosphating baths, heavy metal rinses, etc. Additionally, bare metal substrates being used in the present invention may be a cut edge of a substrate that is otherwise treated and/or coated over the rest of its surface. Alternatively, the substrates may undergo one or more treatment steps known in the art prior to the application of the curable film-forming composition.

Before depositing any coating compositions upon the surface of the substrate, it is common practice, though not necessary, to remove foreign matter or previously applied paints such as OEM coatings from the surface by thoroughly stripping, cleaning and degreasing the surface. When the substrate is not an existing vehicle part, such cleaning typically takes place after forming the substrate (stamping, welding, etc.) into an end-use shape. The surface of the substrate can be cleaned by physical or chemical means, or both, such as mechanically abrading the surface (e.g., sanding) or cleaning/degreasing with commercially available alkaline or acidic cleaning agents which are well known to those skilled in the art, such as sodium metasilicate and sodium hydroxide. A non-limiting example of a cleaning agent is CHEMKLEEN 163, an alkaline-based cleaner commercially available from PPG Industries, Inc.

The coated articles of the present invention may further comprise at least one additional film-forming composition applied on top of the curable film-forming composition and/or as an intervening layer between the curable film-forming composition and the substrate(s). This may comprise an electrodeposited layer, a primer, a sealer, and/or one or more topcoats.

The purpose of applying a sealer over a repair area is to provide a smooth and consistent surface on top of which may be applied the repair topcoat layers. The sealer is expected to provide this smoothness with essentially no sanding, and the sealer is conventionally applied in one to two coats at a total dry film thickness around 25 microns. The sealer may be applied over a previously applied primer to hide the sand scratch marks produced when sanding the primer. Oftentimes, in the absence of a sealer, these sanding marks may be transmitted through to the basecoat and are visible as an optical defect in the repair part. A sealer may also be applied to a partial sand-through repair spot to negate the often variable surface energies created by the multiple exposed surfaces. These variable surface energies sometimes lead to optical defects visible in the basecoat layer (known as “ringing”). In this case, the sealer provides a consistent surface energy layer across the surface, on top of which the topcoat is applied. Because the sealer is applied prior to the repair topcoat and is generally not sanded, the “feather-out” area towards the edge of the repair where the contiguous sealer film blends into the original, unsanded area should be smooth enough to be topcoated without additional processing. It is further desirable for the sealer to dry and be processable within 10 to 15 minutes after application. By “processable” is meant “set to touch” as defined in any of the methods disclosed in ASTM D-5895-13.

A topcoat provides, inter alia, aesthetic properties such as color to the substrate, and may be a direct gloss topcoat or a composite coating system comprising a colored basecoat followed by a clear coat. Such coatings may comprise any known in the art of surface coatings and may comprise curable compositions.

Each coating composition may be applied by known application techniques, such as dipping or immersion, spraying, intermittent spraying, dipping followed by spraying, spraying followed by dipping, brushing, or by roll-coating. Usual spray techniques and equipment for air spraying and electrostatic spraying, either manual or automatic methods, can be used.

After application of a composition, a film is formed by driving solvent, i.e., organic solvent and water, out of the film by heating or by an air-drying period. Suitable drying conditions will depend on the particular composition and/or application, but in some instances a drying time of from about 5 to 30 minutes at a temperature of about room temperature to 60° C. will be sufficient. More than one coating layer of each composition may be applied if desired. Usually between coats, the previously applied coat is flashed; that is, exposed to ambient conditions for the desired amount of time.

The curable film-forming composition of the present invention applied to the substrate typically demonstrates a dry film thickness of at least 50 microns or at least 60 microns, or at least 100 microns, to at most 150 microns or at most 125 microns. Dry film thicknesses may be measured 24 hours after application of the coating when cured at ambient temperatures, using a DUALSCOPE FMP40C with an FD13H probe, available from Fischer Technologies, Inc., according to manufacturer's directions.

The curable film-forming composition of the present invention may be cured at a temperature of at least 0° C., or at least 10° C., or at least 20° C., and at most 60° C., or at most 40° C., or at most 30° C. It is also sandable within two hours of application. For example, the curable film-forming composition of the present invention is sandable within 60 to 120 minutes when cured at a temperature of 20° C. Typically, each coated substrate passes a SANDABILITY TEST less than two hours after application of the curable film-forming composition to the at least one substrate. The primer composition of the present invention may be cured overnight at ambient temperatures or force cured for 30 minutes at 60° C.

In the SANDABILITY TEST, a hand sanding block with dimensions 2.75×5 inches (7×12.7 cm), available from 3M as part number 05440, with gold P320 STICK-IT sandpaper (also available from 3M) is pressed to a coated substrate surface with a force that produces˜1 kg when held on a scale. The block is then moved across the surface 20 times and the coating judged “sandable” when the block travels smoothly and there is no coating left on the paper that cannot be brushed off. Two hours or fewer is considered passing.

Often, after curing the curable film-forming composition on the substrate, the coated article demonstrates an adhesion rating of 0 to 2 within seven days after application of the curable film-forming composition to the substrate, when subjected to ISO 2409:2013(E) using a hand-held single blade cutting tool making cuts with 2 mm spacing. When at least two different substrates are coated, the coated article demonstrates an adhesion rating of 0 to 2 on each of the substrates within seven days after application of the curable film-forming composition to the substrates, when subjected to ISO 2409:2013(E) using a hand-held single blade cutting tool making cuts with 2 mm spacing.

The coated articles of the present invention may be prepared by a method comprising:
(a) applying the curable film-forming composition described above directly to at least a portion of at least one substrate as described above (such as at least two different substrates) to form at least one coated substrate; and
(b) subjecting the at least one coated substrate to a temperature of at least 0° C., or at least 10° C., or at least 20° C., and at most 60° C., or at most 40° C., or at most 30° C. to cause curing of the curable film-forming composition. Each coated substrate passes the SANDABILITY TEST described above less than two hours after application of the curable film-forming composition to the at least one substrate. Additionally or alternatively, each coated substrate demonstrates an adhesion rating of 0 to 2 within seven days after application of the curable film-forming composition to each substrate, when subjected to ISO 2409:2013(E) using a hand-held single blade cutting tool making cuts with 2 mm spacing.

At least one additional film-forming composition as described above may be applied on top of at least a portion of the curable film-forming composition of the present invention.

The following working Examples are intended to further describe the invention. It is understood that the invention described in this specification is not necessarily limited to the examples described in this section. Components that are mentioned elsewhere in the specification as suitable alternative materials for use in the invention, but which are not demonstrated in the working Examples below, are expected to provide results comparable to their demonstrated counterparts. Unless otherwise indicated, all parts are by weight.

### EXAMPLES

Mixtures of polyepoxide functional polymers and pigment for use in preparing curable film-forming compositions were prepared from a list of ingredients as follows.

TABLE 1

| | Ex1 | Ex2 | Ex3 | Ex4 | Ex5 | Ex6 | Ex7 |
|---|---|---|---|---|---|---|---|
| EPON | 0 | 0 | 24.2 | 95.0 | 31.7 | 50.4 | 43.4 |
| 1001-T-75^{a} | | | | | | | |
| EPON 828^{b} | 0 | 22.7 | 0 | 0 | 0 | 0 | 0 |
| DEN 431^{c} | 21.8 | 0 | 0 | 0 | 0 | 0 | 0 |
| N-butyl | 67.8 | 67.8 | 67.8 | 67.8 | 67.8 | 67.8 | 67.8 |
| acetate | | | | | | | |
| Methyl amyl | 3.1 | 3.1 | 3.1 | 3.1 | 3.1 | 3.1 | 3.1 |
| ketone | | | | | | | |
| Crayvallac | 0.3 | 0.3 | 0.3 | 0.3 | 0.3 | 0.3 | 0.3 |
| A-72-260-A^{d} | | | | | | | |
| Nuosperse | 1.2 | 1.2 | 1.2 | 1.2 | 1.2 | 1.2 | 1.2 |
| 657 na^{e} | | | | | | | |
| Bentone | 0.4 | 0.4 | 0.4 | 0.4 | 0.4 | 0.4 | 0.4 |
| SD-2^{f} | | | | | | | |
| Bentone 38^{f} | 0.6 | 0.6 | 0.6 | 0.6 | 0.6 | 0.6 | 0.6 |
| Acematt ok | 0.6 | 0.6 | 0.6 | 0.6 | 0.6 | 0.6 | 0.6 |
| 412^{g} | | | | | | | |
| Raven 410 | 0.3 | 0.3 | 0.3 | 0.3 | 0.3 | 0.3 | 0.3 |
| carbon black | | | | | | | |
| powder^{h} | | | | | | | |
| Nicron 665ⁱ | 25.7 | 25.7 | 25.7 | 25.7 | 25.7 | 25.7 | 25.7 |
| ASP-200^{j} | 15.4 | 15.4 | 15.4 | 15.4 | 15.4 | 15.4 | 15.4 |
| Tiona 595^{k} | 25.7 | 25.7 | 25.7 | 25.7 | 25.7 | 25.7 | 25.7 |
| Bartex 10^{l} | 27.1 | 27.1 | 27.1 | 27.1 | 27.1 | 27.1 | 27.1 |

^{a,b}polyepoxide functional polymers available from Hexion
^{c}Novolac based polyepoxide functional polymer available from Palmer Holland
^{d}rheology modifier available from Arkema INC
^{e}dispersing agent available from Elementis Specialties
^{f}organic derivatives of bentonite clay available from Evonik
^{g}matting agent available from Palmer Holland
^{h}available from Birla Carbon
ⁱtalc available from Imerys Performance Additives
^{j}kaolin available from BASF
^{k}titanium dioxide available from Cristal Global
^{l}barium sulfate available from TOR Minerals International

For each example, the mass (grams) of materials listed in Table 1 was added to a vessel with 200 g of 1.2-1.6 mm ZIRCONOX milling media and dispersed on a LAU disperser DAS 200 (LAU GmbH) for 2-4 hours. These dispersions had a fineness of grind reading of greater than 5 as described in ASTM D1210.

TABLE 2

| | | | Ex10 | Ex11 | Ex12 | | |
|---|---|---|---|---|---|---|---|
| | Ex8 | Ex9 | (Comp) | (Comp) | (Comp) | Ex13 | Ex14 |
| Ex1 | 190.1 | | | | | | |
| Ex2 | | 191.0 | | | | | |
| Ex3 | | | 192.5 | | | | |
| Ex4 | | | | 263.3 | | | |
| Ex5 | | | | | 199.9 | | |
| Ex6 | | | | | | 218.7 | |
| Ex7 | | | | | | | 211.7 |
| Silquest | 3.6 | 3.6 | 3.6 | 5.0 | 3.3 | 3.7 | 3.6 |
| A-187^{a} | | | | | | | |
| n-butyl | 54.8 | 55.3 | 55.3 | 81.7 | 44.2 | 62.4 | 55.2 |
| acetate | | | | | | | |
| PETMP | 10.4 | 9.9 | 0.0 | 11.9 | 4.0 | 6.3 | 5.4 |
| Thiocure^{b} | | | | | | | |
| Thioplast | 0.0 | 0.0 | 22.3 | 0.0 | 0.0 | 0.0 | 0.0 |
| G1^{c} | | | | | | | |
| Delfleet | 25.9 | 24.8 | 7.6 | 29.7 | 9.9 | 0.0 | 13.6 |
| Evolution | | | | | | | |
| F3996^{d} | | | | | | | |
| Accelerat | 0.0 | 0.0 | 0.0 | 0.0 | 0.0 | 1.5 | 0.0 |
| or | | | | | | | |
| 2950CH^{e} | | | | | | | |

^{a}epoxy functional silane available from Momentive Performance Materials
^{b}Pentaerythritol tetrakis(3-mercaptopropionate) available from Bruno Bock GMBH
^{c}polysulfide available from Akzo Nobel Chemicals
^{d}36 percent by weight solution of polyamidoamine and amine catalyst in solvent available from PPG Industries Automotive Refinish
^{e}Co-reacting mixture of catalyst and phenolic polyamine available from Huntsman

Curable film-forming compositions were prepared by mixing each ingredient in Table 2 the order listed. Example 10 is comparative because it contains polysulfide (see footnote c in Table 2) but no other polythiols. Example 11 is comparative because the pigment to binder ratio is less than 1. Example 12 is comparative because the pigment to binder ratio is equal to 3.

The compositions were applied by spray application using a 1.4 mm tip SATA HVLP applicator to give 3-5 mil dry films. The compositions were applied to 4×12 inch cold rolled steel, aluminum 6061T3, and electrogalvanized panels (available from ACT: part numbers 18661, 10288, 19081). These panels were prepared by abrading with P180 grit sanding disc using a dual-action air-powered disc sander, and cleaned using hydrocarbon degreaser.

Time to sand was determined using the SANDABILITY TEST described above. Two hours or fewer is considered passing.

Adhesion was tested 7 days after application using crosshatch and tape pull off as described ISO 2409:2013(E) using a hand-held single blade cutting tool making cuts with 2 mm spacing, and reported as described in the method. A 0-2 rating is considered passing while a 3-5 rating is failing.

| | | ISO2409 | ISO2409 | |
|---|---|---|---|---|
| | ISO2409 | adhesion to | adhesion to | Time to sand |
| | adhesion to | cold rolled | electrogalvanized | (hours after |
| Example | aluminum | steel | steel | application) |
| 8 | 2 | 1 | 1 | 2 |
| 9 | 1 | 1 | 2 | 2 |
| 10 | 3 | 1 | 1 | >2 |
| 11 | 5 | 0 | 0 | >2 |
| 12 | 4 | 4 | 2 | 2 |
| 13 | 2 | 0 | 1 | 1 |
| 14 | 1 | 1 | 1 | 2 |

Examples 8, 9, and 14 demonstrate that curable film-forming compositions of the present invention that contain aromatic epoxy resins demonstrate adhesion to a variety of substrates as well as fast sandability.

Examples 10 and 14 show that not all thiol resins produce acceptable adhesion and sanding. In Example 14, a polythiol functional compound with 3 or more thiols per molecule produces acceptable adhesion and sanding times. Comparative Example 10, which includes a polysulfide resin, does not have acceptable sanding or adhesion.

In Example 13, a small amount of a phenolic polyamine produces acceptable adhesion and a sandable coating in 1 hour. Example 14, with a polyamidoamine resin, produces acceptable adhesion and a sandable coating in 2 hours.

Examples 11, 12, and 14 demonstrate that not all weight ratios of pigment to resin solids produces acceptable adhesion and sanding times. Comparative Example 11, with a P:B ratio of 1, does not have acceptable adhesion or sanding. Comparative Example 12, with a P:B ratio of 3, does not have acceptable adhesion. Example 14, with a P:B ratio of 2.2, has acceptable sanding and adhesion.

Whereas particular examples of this invention have been described above for purposes of illustration, it will be evident to those skilled in the art that numerous variations of the details of the present invention may be made without departing from the invention as defined in the appended claims.

Although various embodiments of the invention have been described in terms of “comprising”, embodiments consisting essentially of or consisting of are also within the scope of the present invention.

1. A curable film-forming composition comprising:
(a) a polyepoxide functional polymer;
(b) a polythiol functional compound, wherein the polythiol functional compound comprises at least two or at least three thiol functional groups and wherein if the polythiol functional compound contains hydroxyl functional groups, the ratio of thiol functional groups to hydroxyl functional groups within the polythiol functional compound is not 1:1;
(c) a reactive compound different from the polythiol functional compound (b), containing multiple pendant and/or terminal functional groups selected from carboxylic acid, anhydride, amine and phenol that are reactive with epoxide functional groups; and
(d) a pigment; wherein the curable film-forming composition demonstrates a pigment to binder ratio greater than or equal to 2 and less than 3.

2. The curable film-forming composition of claim 1 wherein the weight ratio of the polythiol functional compound (b) to the reactive compound (c) is less than or equal to 10.

3. (canceled)

4. The curable film-forming composition of claim 1 wherein the polyepoxide functional polymer (a) comprises less than 25 percent by weight of an acrylic polyepoxide functional polymer, based on the total weight of polyepoxide functional polymer (a) in the curable film-forming composition.

5. (canceled)

6. The curable film-forming composition of claim 1 wherein if the polythiol functional compound (b) contains hydroxyl functional groups, the ratio of thiol functional groups to hydroxyl functional groups within the polythiol functional compound (b) is greater than 1:1.

7. (canceled)

8. The curable film-forming composition of claim 1 wherein the polythiol functional compound (b) has a thiol equivalent weight less than 330 g/equivalent, or less than 300 g/equivalent, or less than 200 g/equivalent, or less than 135 g/equivalent.

9. The curable film-forming composition of claim 1 wherein the polythiol functional compound (b) comprises a reaction product of a thiol-functional organic acid and a polyol.

10-13. (canceled)

14. The curable film-forming composition of claim 1 wherein the reactive compound (c) comprises a polyamidoamine and/or a phenolic.

15-18. (canceled)

19. A coated article comprising a substrate and the curable film-forming composition of claim 1 applied to at least one surface of the substrate.

20. The coated article of claim 19, wherein after curing the curable film-forming composition on the substrate, the coated article demonstrates an adhesion rating of 0 to 2 within seven days after application of the curable film-forming composition to the substrate, when subjected to ISO 2409:2013(E) using a hand-held single blade cutting tool making cuts with 2 mm spacing.

21. A coated article comprising at least two different substrates and the curable film-forming composition of claim 1 applied to at least one surface of each of the substrates.

22. The coated article of claim 21, wherein after curing the curable film-forming composition on the substrates, the coated article demonstrates an adhesion rating of 0 to 2 on each of the substrates within seven days after application of the curable film-forming composition to the substrates, when subjected to ISO 2409:2013(E) using a hand-held single blade cutting tool making cuts with 2 mm spacing.

23. The coated article of claim 19, further comprising at least one additional film-forming composition applied on top of the curable film-forming composition and/or between the curable film-forming composition and the substrate(s).

24. The coated article of claim 19, wherein the coated article comprises a component of a vehicle, building, bridge, industrial protective structure, ship, railcar, railcar container, water tower, power line tower, tunnel, oil or gas industry structure, marine structure, aerospace structure, bridge support structure, pipeline, oil rig, storage tank, or wind turbine.

25. A method of forming a coated article, comprising:
(a) applying the curable film-forming composition of claim 1 directly to at least a portion of at least one substrate to form at least one coated substrate; and
(b) subjecting the at least one coated substrate to a temperature of at least 0° C., or at least 10° C., or at least 20° C., and at most 60° C., or at most 40° C., or at most 30° C. to cause curing of the curable film-forming composition.

26. The method of claim 25, wherein each coated substrate passes SANDABILITY TEST less than two hours after application of the curable film-forming composition to the at least one substrate, and/or wherein each coated substrate demonstrates an adhesion rating of 0 to 2 within seven days after application of the curable film-forming composition to each substrate, when subjected to ISO 2409:2013(E) using a hand-held single blade cutting tool making cuts with 2 mm spacing.

27-28. (canceled)

29. The method of claim 25, wherein the curable film-forming composition is applied directly to at least a portion of at least two different substrates.

30-31. (canceled)

32. The method of claim 25, wherein the curable film-forming composition comprises a primer, sealer, basecoat, or direct gloss topcoat, and imparts a decorative and/or protective finish to the substrates, and wherein when the curable film-forming composition comprises a primer, sealer, or basecoat, the method further comprises applying at least one additional film-forming composition on top of at least a portion of the curable film-forming composition.

33-34. (canceled)

35. A coated article prepared by the method of claim 25.

36. A coating kit comprising:
(a) a polyepoxide functional polymer;
(b) a polythiol functional compound, wherein the polythiol functional compound comprises at least two or at least three thiol functional groups and wherein if the polythiol functional compound contains hydroxyl functional groups, the ratio of thiol functional groups to hydroxyl functional groups within the polythiol functional compound is not 1:1;
(c) a reactive compound different from the polythiol functional compound (b), containing multiple pendant and/or terminal functional groups selected from carboxylic acid, anhydride, amine and phenol that are reactive with epoxide functional groups; and
(d) a pigment; wherein the curable film-forming composition demonstrates a pigment to binder ratio greater than or equal to 2 and less than 3.

37. The coating kit of claim 36 comprising multiple, separate components, wherein a first component comprises the polyepoxide functional polymer (a), a second component comprises the polythiol functional compound (b), and a third component comprises the reactive compound (c), and wherein the pigment (d) is present in the first component and/or the third component.
